(19) United States
(12) Patent Application Publication
(10) Pub. No.: US 2017/0337901 A1
(43) Pub. Date: Nov. 23, 2017

(54) DISPLAYING GRAPHICS IN A VEHICLE DISPLAY

(71) Applicant: Google Inc., Mountain View, CA (US)

(72) Inventors: Pavel Aleksandrovich Maltsev, San Jose, CA (US); Keun Young Park, Santa Clara, CA (US)

(21) Appl. No.: 15/393,080

(22) Filed: Dec. 28, 2016

Related U.S. Application Data
(60) Provisional application No. 62/338,342, filed on May 18, 2016.

(51) Int. Cl. G09G 5/14; G06T 11/60; B60R 11/02

(52) U.S. Cl. CPC G09G 5/14; B60R 11/0229; G06T 11/60

(57) ABSTRACT

Methods, systems, and apparatus, including computer programs encoded on a computer storage medium, for display graphics in a vehicle display. In one aspect, a method includes the actions of determining that an application that displays data in a non-safety critical information portion of a vehicle display has launched, wherein the vehicle display displays non-safety critical information in the non-safety critical information portion and safety critical information in a safety critical information portion of the display; providing, to a vehicle system that manages the vehicle display, context that characterizes the application; receiving, from the vehicle system, display state information that identifies an area of the vehicle display that is currently allocated to the non-safety critical information portion; generating, using the display state information, application display information that defines an area allocated for displaying the non-safety critical information generated by the application; and providing the application display information to the application.

### CROSS REFERENCE TO RELATED APPLICATIONS

This application is a non-provisional of and claims priority to U.S. Provisional Patent Application No. 62/338,342, filed on May 18, 2016, the entire contents of which are hereby incorporated by reference.

### BACKGROUND

This specification generally relates to a vehicle display.

### SUMMARY

In general, one innovative aspect of the subject matter described in this specification can be embodied in methods that include the actions of determining that an application that displays data in a non-safety critical information portion of a vehicle display has launched, wherein the vehicle display displays non-safety critical information in the non-safety critical information portion and safety critical information in a safety critical information portion of the display; providing, to a vehicle system that manages the vehicle display, context that characterizes the application; receiving, from the vehicle system, display state information that identifies an area of the vehicle display that is currently allocated to the non-safety critical information portion; generating, using the display state information, application display information that defines an area allocated for displaying the non-safety critical information generated by the application; and providing the application display information to the application.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination. The method includes receiving graphics data from the application; and providing, to the vehicle system, the graphics data for display in the non-safety critical information portion of the vehicle display. The application display information defines the area allocated for displaying the graphics data generated by the application as an area that substantially matches the area of the vehicle display that is currently allocated to the non-safety critical information portion. The application display information defines the area allocated for displaying the graphics data generated by the application as one window within the area of the vehicle display that is currently allocated to the non-safety critical information portion. The application display information defines the area allocated for displaying the graphics data generated by the application as one window that is overlaid, in part or in full, over the area of the vehicle display that is currently allocated to the non-safety critical information portion. The application display information defines the area allocated for displaying the graphics data generated by the application as multiple windows within the area of the vehicle display that is currently allocated to the non-safety critical information portion. The application display information defines the area allocated for displaying the graphics data generated by the application as a first window and a second window that is smaller than the first window and is overlaid over the first window. The method includes determining a display capability of the application; and generating the application display information to define the area in a manner that is appropriate for the display capability of the application.

Particular embodiments of the subject matter described in this specification can be implemented so as to realize one or more of the following advantages. A conventional vehicle system communicates with applications that provide graphics data for display in a vehicle display. Since each vehicle manufacturer uses a different vehicle system and a different vehicle display, it is hard to develop an application that provides graphics data to fit for all vehicle systems and vehicle displays. Compared to the conventional vehicle system, a vehicle system interacts with a user display system. Since the user display system communicates with applications and provides context characterizing the applications to the vehicle system, the vehicle system can determine which portion of the vehicle display is allocated for display the graphics data provided by the applications. The user display system provides the information regarding the portion allocated for display the graphics data to the applications. Thus, the applications can generate graphics data to fit for the given portion of the vehicle display. As a result, the vehicle display can seamlessly present the graphics data to a user.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example vehicle display for displaying safety critical information and non-safety critical information.

FIG. 2 is a diagram illustrating an example user display system that provides graphics data for display in a non-safety critical information portion of a vehicle display.

FIGS. 3A-3B are diagrams illustrating example representations of the area that is allocated for displaying non-safety critical information in a non-safety critical information portion of a vehicle display.

FIGS. 4A-4B are diagrams illustrating example representations of the area that is allocated for displaying non-safety critical information in a non-safety critical information portion of a vehicle display.

FIGS. 5A-5B are diagrams illustrating example representations of the area that is allocated for displaying non-safety critical information in a non-safety critical information portion of a vehicle display.

FIGS. 6A-6B are diagrams illustrating example representations of the area that is allocated for displaying non-safety critical information in a non-safety critical information portion of a vehicle display.

FIGS. 7A-7B are diagrams illustrating example representations of the area that is allocated for displaying non-safety critical information in a non-safety critical information portion of a vehicle display.

FIGS. 8A-8B are diagrams illustrating examples of the areas that are allocated for displaying non-safety critical information in non-safety critical information portions of a vehicle display.

FIG. 9 is a flowchart of an example method of providing graphics data for display in a non-safety critical information portion of a vehicle display.

Like reference numbers and designations in the various drawings indicate like elements.

### DETAILED DESCRIPTION

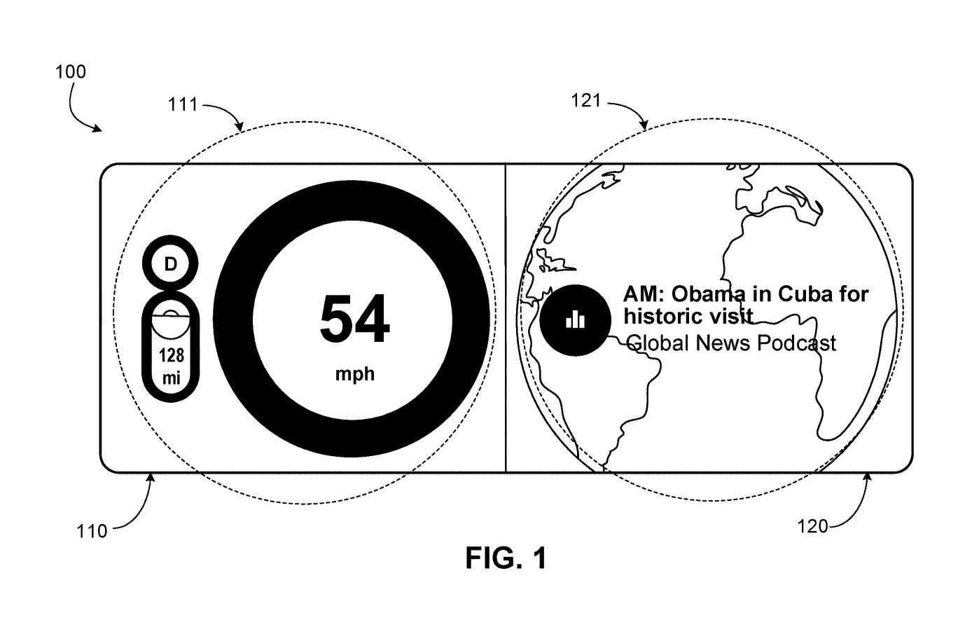

FIG. 1 is a diagram of an example vehicle display 100 for displaying safety critical information and non-safety critical information. The vehicle display 100 includes a safety critical information portion 110 and a non-safety critical information portion 120. While shown as rectangular in FIG. 1, the vehicle display 100 can have various shapes. For example, the vehicle display 100 can be any of rectangular, trapezoidal, oval, circular, semi-circular, trapezoidal, elliptical, and so on.

The vehicle display 100 is a display integrated within a vehicle that displays vehicle information for viewing by the operator of the vehicle during operation of the vehicle. For example, the vehicle may be a car, truck, bus, motorcycle, wagon, bicycle, watercraft, aircraft, spacecraft, and so on. In the context of an automobile, the vehicle display may be a dashboard display, e.g., an electronic instrument cluster or a digital instrument panel, a display in a center console, a headrest monitor, and so on.

The safety critical information portion 110 displays safety critical information. Safety critical information is information related to ensuring the safety of a vehicle or a user of the vehicle. For example, the safety critical information portion 110 can display one or more of current vehicle speed, revolutions per minute (RPM) of the vehicle engine, engine temperature, safety warnings, coolant temperature, oil level, condition of braking system, oil pressure, battery charging level, tire condition, and so on. Referring to FIG. 1, the safety critical information portion 110 displays current speed information 111 of the vehicle. In some implementations, the safety critical information portion 110 can display additional safety critical information as described above.

The non-safety critical information portion 120 displays non-safety critical information. Non-safety critical information is information that is not related to ensuring the safety of a vehicle or a user. For example, the non-safety critical information may include user information such as notification information or entertainment information. In addition, the non-safety critical information may include vehicle information such as navigation information. Referring to FIG. 1, the non-safety critical portion 120 displays entertainment information 121.

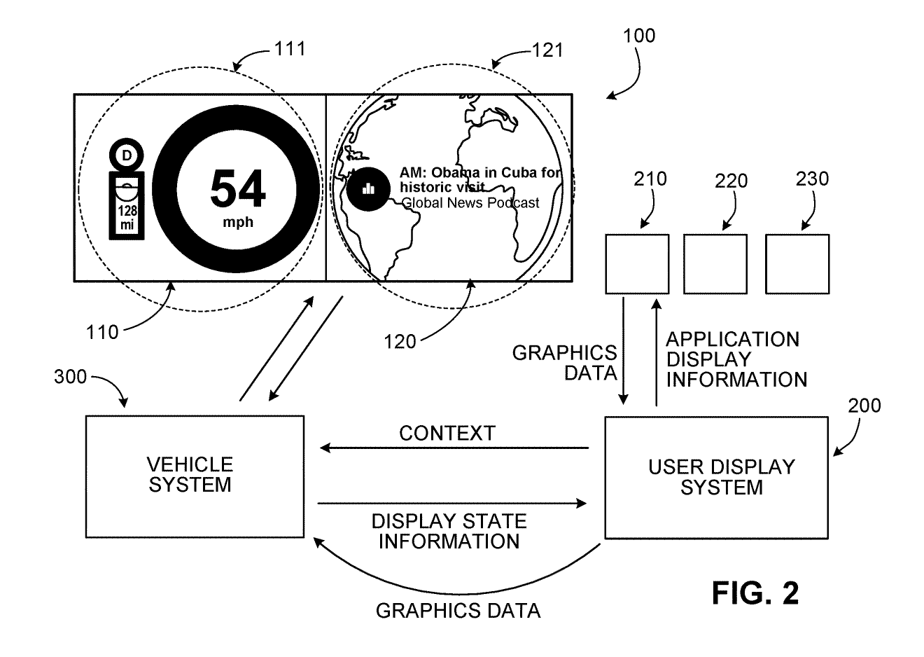

FIG. 2 is a diagram showing an example user display system 200 that provides graphics data for display in a non-safety critical information portion of a vehicle display. The user display system 200 is an example of a system implemented as computer programs on one or more computers in one or more locations, in which the systems, components, and techniques described below can be implemented. In some implementations, the one or more computers are part of an integrated computer system within the vehicle. In some implementations, the one or more computers are part of external device that is connected with a vehicle system 300 using a wireless communication protocol, e.g., Bluetooth, Wi-Fi, 3G, and 4G.

Depending on the implementation, the user display system 200 can communicate with the vehicle system 300 using any of a variety of techniques. In some implementations, the user display system 200 and the vehicle system 300 can both be a part of one system on chip and share a memory or send data through shared communication channels. In some implementations, the user display system 200 and the vehicle system 300 can be implemented on different chipsets and the user display system 200 communicates with the vehicle system 300 through wired or wireless communication channels. In some implementations, the user display system 200 can communicate with the vehicle system 300 using a dedicated communication channel for particular data, e.g., graphics data. In this example, the user display system 200 may communicate with the vehicle display 300 using other communication channels for other types of data.

The vehicle system 300 manages the vehicle display 100. The vehicle system 300 determines which safety critical information is displayed in the safety critical information portion 110 of the vehicle display 100. For example, the vehicle system 300 can selectively determine one or more of current vehicle speed, RPM of the vehicle engine, engine temperature, safety warnings, coolant temperature, oil level, condition of braking system, oil pressure, battery charging level, and tire condition to be displayed in the safety critical information portion 110 of the vehicle display 100.

In addition, the vehicle system 300 determines how much of the display area of the vehicle display 100 should be allocated to the safety critical information portion 110 and how much should be allocated to the non-safety critical information portion 120 at any given time. That is, the vehicle system 300 may vary how much of the display area of the vehicle display 100 is allocated to the non-safety critical information portion 120 at various times during the operation of the vehicle.

In particular, the vehicle system 300 determines the areas allocated to each of the portions by interacting with the user display system 200. The vehicle system 300 may determine the area that is allocated for the non-safety critical information portion 120 based on context provided by the user display system 200. The context includes data that characterizes an application that provides graphics data to be displayed in the non-safety critical information portion 120.

The user display system 200 facilitates the display of graphics data generated by applications, e.g., applications 210, 220, 230, in the non-safety critical information portion 120 of the vehicle display 100. The data provided by the applications 210, 220, 230 for presentation in the non-safety critical information portion 120 may include graphics data including texts, pictures, or any visual graphics that can be displayed in the vehicle display 100.

For example, the application 210 can be a navigation application that provides navigation data for displaying in the non-safety critical information portion 120 of the vehicle display 100. The navigation data may include texts or graphics indicating maps, signs, directions, or distances. The second application 220 can provide entertainment data for displaying in the non-safety critical information portion 120 of the vehicle display 100. The entertainment data may include texts or graphics indicating title of song, artist name, time played, time remaining, an album cover, or present channel that a user is listening to. The third application 230 can provide notification data for displaying in the non-safety critical information portion 120 of the vehicle display 100. The notification data may include texts or graphics indicating content of a message or email, a sender of a message or email, or a name or phone number of a caller.

To facilitate the display of data generated by an application, the user display system 200 provides context to the vehicle system 300 in response to one of the applications being launched. Context includes data that characterizes the launched application. For example, the data that characterizes the launched application can be data that identifies the name of the launched application, the type of the launched application, or the current state of the launched application. When any one of the applications 210, 220, 230 has launched, the user display system 200 provides context that characterizes the launched application to the vehicle system 300.

In some implementations, where multiple applications are running at once, the context may include data that characterizes each of the multiple applications. In some implementations, where one application has launched while another application is already running, the user display system 200 can provide updated context including data that characterizes the newly launched application to the vehicle system 300. In some implementations, where the current state of the launched application has changed, the user display system 200 can provide updated context including data that characterizes the changed state of the application to the vehicle system 300. For example, where a navigation application is launched, when a user enters destination information, the user display system 200 provides the vehicle system 300 with context including data that characterizes the state that the navigation application receives a user input. When the navigation application starts the navigation, the user display system 200 can provide updated context that characterizes the changed state that the navigation application begins the navigation.

The vehicle system 300 receives the context from the user display system 200. Based on the context, the vehicle system 300 determines how much of the display area of the vehicle display 100 should be allocated to the non-safety critical information portion and generates display state information that includes data that identifies the area allocated to the non-safety critical information portion 120 within the vehicle display 100.

In some implementations, the display state information includes data that determines the sizes and arrangements of the safety critical information portion 110 and the non-safety critical information portion 120. For example, if the vehicle system 300 receives the context that characterizes a navigation application, the vehicle system 300 can allocate the ⅓ area of the vehicle display 100 to the safety critical information portion 110 and allocate the ⅔ area of the vehicle display 100 to the non-safety critical information portion 120. As another example, the vehicle system 300 can allocate the central area of the vehicle display 100 to the non-safety critical information portion 120 and allocate the edge areas of the vehicle display 100 to the safety critical information portion 120.

If the vehicle system 300 receives context that characterizes a different application such as an entertainment application or a notification application or data identifying a changed state of the navigation application, the vehicle system 300 can allocate different areas for the safety critical information portion 110 and the non-safety critical information portion 120 based on the context.

The user display system 200 receives the display state information from the vehicle system 300 and generates application display information using the display state information. The application display information includes data defining an area that is allocated for displaying data generated by the launched application.

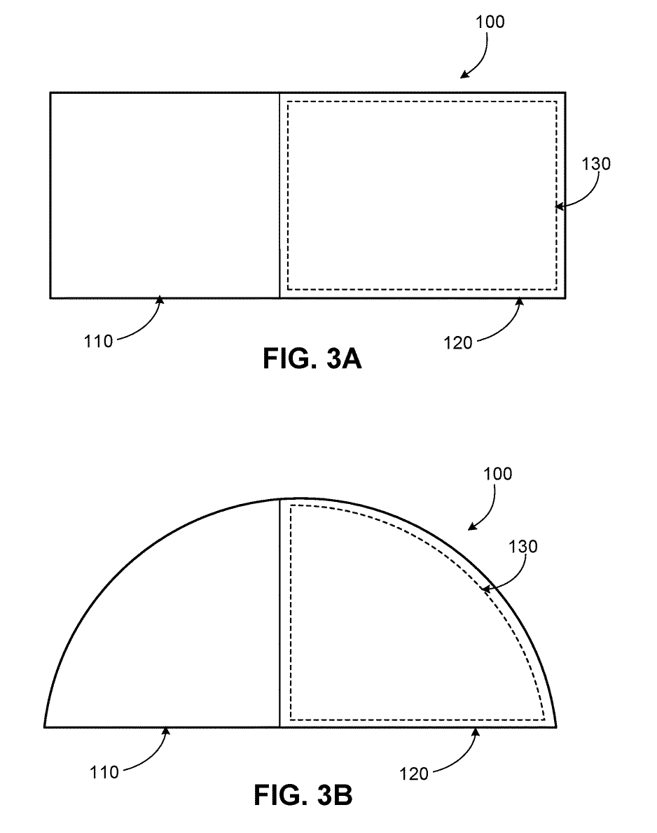

In some implementations, the user display system 200 can generate the application display information based on the display capabilities of the launched application. To generate the application display information, the user display system 200 determines the display capability of the launched application and generates the application display information to define the area that is allocated for displaying the non-safety critical information in a manner that is appropriate for the display capability of the launched application. Example representations of the area that is allocated for displaying non-safety critical information are described in greater detail below with respect to FIGS. 3A-7B.

The user display system 200 provides the application display information to the launched application. The launched application receives the application display information and generates graphics data to be displayed in the area that is allocated for displaying non-safety critical information. For example, where the launched application is a navigation application, the navigation application generates graphics data including texts or graphics indicating maps, signs, directions, time, or distances to be displayed in the area allocated for displaying the non-safety critical information.

The launched application provides the graphics data to the user display system 200. The user display system 200 provides the received graphics data to the vehicle system 300 for display in the non-safety critical information portion of the vehicle display. The vehicle system 300 displays the graphics data in the non-safety critical information portion 120 of the vehicle display 100.

As mentioned above, the user display system 200 allows the application to provide the graphics data to fit for the portion allocated for display the non-safety critical information in the vehicle display 100. Thus, the user display system 200 enables the application to seamlessly provide the graphics data to any vehicle system and vehicle display. As a result, the user display system 200 improves the user experience of a driver or a passenger viewing the vehicle display.

FIGS. 3A-3B are diagrams illustrating example representations of the area that is allocated for displaying non-safety critical information in a non-safety critical information portion of a vehicle display. When the user display system 200 receives the display state information, the user display system 200 identifies an area of the vehicle display that is allocated to a non-safety critical information portion. Referring to FIGS. 3A and 3B, the area 120 is the area allocated to the non-safety critical information portion.

The user display system 200 generates application display information using the display state information. The application display information includes data defining an area that is allocated for displaying non-safety critical information generated by an application. The user display system 200 generates the application display information defining the area allocated for displaying graphics data generated by a launched application as an area 130 that substantially matches the area 120 of the vehicle display 100 that is currently allocated to the non-safety critical portion.

In some implementations, referring to FIG. 3A, where the vehicle display 100 is rectangular, the application display information defines the area 130 substantially matching the area 120. The user display system 200 may obtain border line of the area 120 and generate the application display information defining the area 130 substantially matching the border line of the area 120.

In some implementations, referring to FIG. 3B, where the vehicle display 100 is semi-circular, the application display information defines the area 130 substantially matching the area 120. The user display system 200 may obtain border line of the area 120 and generate the application display information defining the area 130 substantially matching the border line of the area 120.

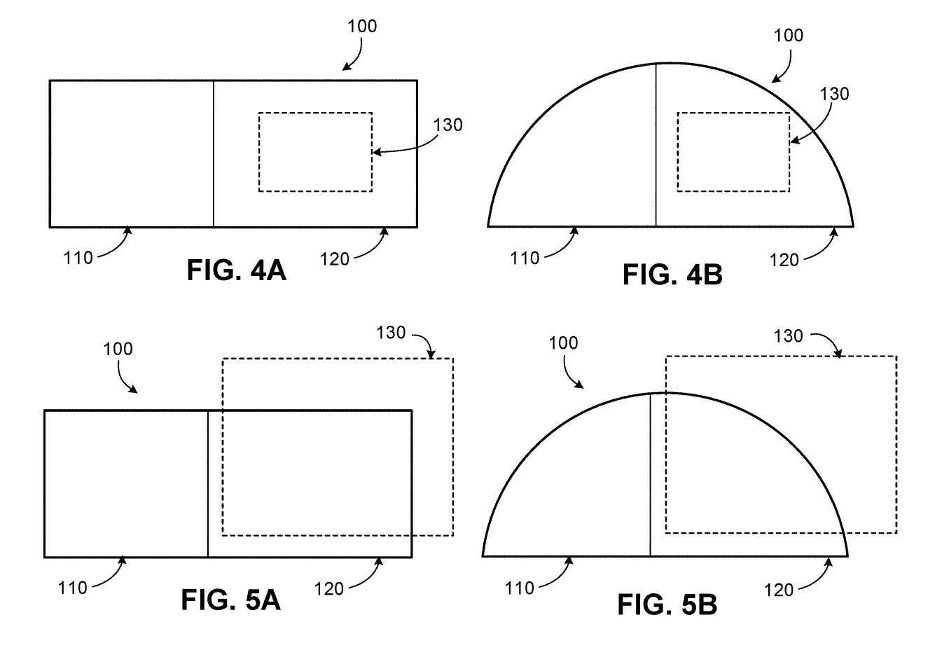

FIGS. 4A-4B are diagrams illustrating example representations of the area that is allocated for displaying non-safety critical information in a non-safety critical information portion of a vehicle display. When the user display system 200 receives the display state information, the user display system 200 identifies an area of the vehicle display that is allocated to a non-safety critical information portion. Referring to FIGS. 4A and 4B, the area 120 is the area allocated to the non-safety critical information portion.

The user display system 200 generates application display information using the display state information. The application display information includes data defining an area that is allocated for displaying non-safety critical information generated by an application. The user display system 200 generates the application display information defining the area allocated for displaying graphics data generated by a launched application as a window 130 within the area 120 of the vehicle display 100 that is currently allocated to the non-safety critical portion.

In some implementations, referring to FIG. 4A, where the vehicle display 100 is rectangular, the application display information defines the window 130 that is within the area 120. The vehicle system 300 can display the graphics data received from the launched application in the window 130.

In some implementations, referring to FIG. 4B, where the vehicle display 100 is semi-circular, the application display information defines the window 130 that is within the area 120. The vehicle system 300 can display the graphics data received from the launched application in the window 130.

FIGS. 5A-5B are diagrams illustrating example representations of the area that is allocated for displaying non-safety critical information in a non-safety critical information portion of a vehicle display. When the user display system 200 receives the display state information, the user display system 200 identifies an area of the vehicle display that is allocated to a non-safety critical information portion. Referring to FIGS. 5A and 5B, the area 120 is the area allocated to the non-safety critical information portion.

The user display system 200 generates application display information using the display state information. The application display information includes data defining an area that is allocated for displaying non-safety critical information generated by an application. The user display system 200 generates the application display information defining the area allocated for displaying graphics data generated by a launched application as a window 130 that is overlaid, in part or in full, over the area 120 of the vehicle display 100 that is currently allocated to the non-safety critical portion.

In some implementations, referring to FIG. 5A, where the vehicle display 100 is rectangular, the application display information defines the window 130 that is overlaid in part over the area 120. In some implementations, the application display information defines the window 130 that is overlaid in full, that is, incorporating, the area 120. The vehicle system 300 can display the graphics data received from the launched application in the area 130.

In some implementations, referring to FIG. 5B, where the vehicle display 100 is semi-circular, the application display information defines the window 130 that is overlaid in part over the area 120. The application display information defines the window 130 that is overlaid in full, that is, incorporating, the area 120. The vehicle system 300 can display the graphics data received from the launched application in the window 120.

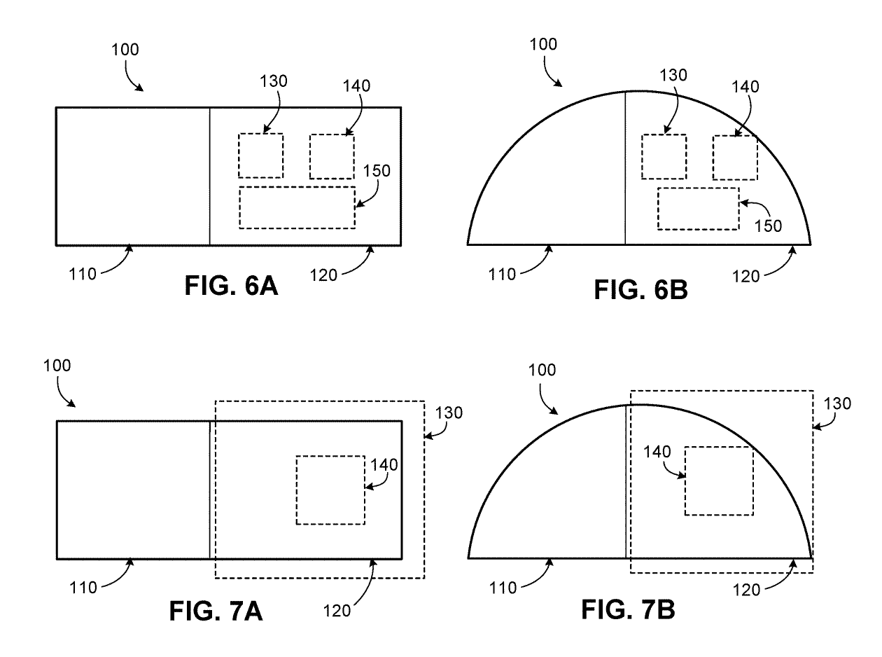

FIGS. 6A-6B are diagrams illustrating example representations of the area that is allocated for displaying non-safety critical information in a non-safety critical information portion of a vehicle display. When the user display system 200 receives the display state information, the user display system 200 identifies an area of the vehicle display that is allocated to a non-safety critical information portion. Referring to FIGS. 6A and 6B, the area 120 is the area allocated to the non-safety critical information portion.

The user display system 200 generates application display information using the display state information. The application display information includes data defining an area that is allocated for displaying non-safety critical information generated by an application. The user display system 200 generates the application display information defining the area allocated for displaying graphics data generated by a launched application as multiple windows 130, 140, 150 within the area 120 of the vehicle display 100 that is currently allocated to the non-safety critical portion.

In some implementations, referring to FIG. 6A, where the vehicle display 100 is rectangular, the application display information defines the multiple windows 130, 140, 150 that are within the area 120.

In some implementations, referring to FIG. 6B, where the vehicle display 100 is semi-circular, the application display information defines the multiple windows 130, 140, 150 that are within the area 120.

FIGS. 7A-7B are diagrams illustrating example representations of the area that is allocated for displaying non-safety critical information in a non-safety critical information portion of a vehicle display. When the user display system 200 receives the display state information, the user display system 200 identifies an area of the vehicle display that is allocated to a non-safety critical information portion. Referring to FIGS. 7A and 7B, the area 120 is the area allocated to the non-safety critical information portion.

The user display system 200 generates application display information using the display state information. The application display information includes data defining an area that is allocated for displaying non-safety critical information generated by an application. The user display system 200 generates the application display information defining the area allocated for displaying graphics data generated by a launched application as multiple windows 130, 140, 150 within the area 120 of the vehicle display 100 that is currently allocated to the non-safety critical portion.

In some implementations, referring to FIG. 7A, where the vehicle display 100 is rectangular, the application display information defines a first window 130 and a second window 140 that is smaller than the first window 130 and is overlaid over the first window 130.

In some implementations, referring to FIG. 7B, where the vehicle display 100 is semi-circular, the application display information defines a first window 130 and a second window 140 that is smaller than the first window 130 and is overlaid over the first window 130.

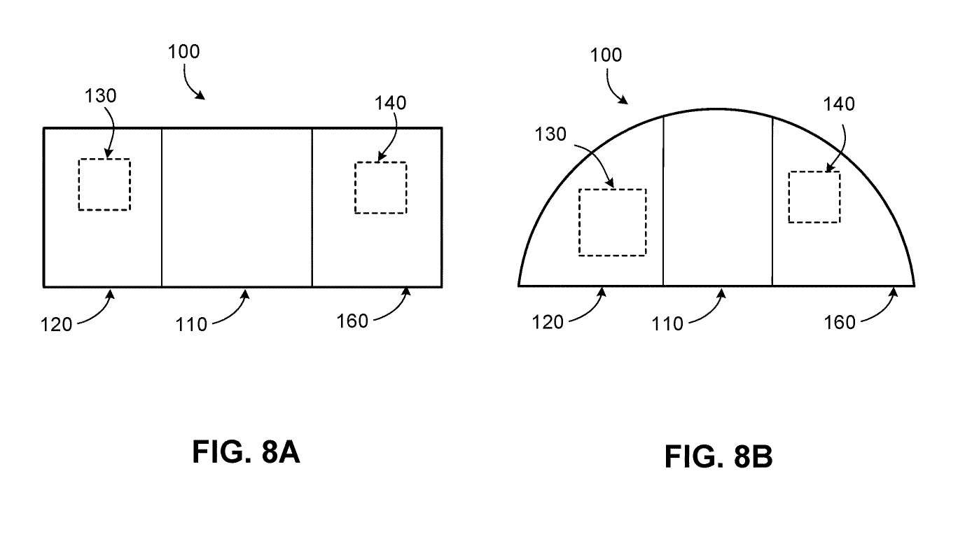

FIGS. 8A-8B are diagrams illustrating examples of multiple areas being allocated for displaying non-safety critical information in non-safety critical information portions of a vehicle display. When the user display system 200 receives the display state information, the user display system 200 identifies multiple areas of the vehicle display that are allocated to non-safety critical information portions. Referring to FIGS. 8A and 8B, the areas 120, 160 are the areas allocated to the non-safety critical information portions.

The user display system 200 generates application display information using the display state information. The application display information includes data defining the multiple areas that are allocated for displaying non-safety critical information generated by an application. The user display system 200 generates the application display information defining the area allocated for displaying graphics data generated by a launched application as a window 130 within the area 120 of the vehicle display 100 that is currently allocated to the non-safety critical portion and defining the area allocated for displaying graphics data generated by a launched application as a window 140 within the area 160 of the vehicle display 100 that is currently allocated to the non-safety critical portion.

In some implementations, referring to FIG. 8A, where the vehicle display 100 is rectangular, the application display information defines the window 130 within the area 120 and the window 140 within the area 160.

In some implementations, referring to FIG. 8B, where the vehicle display 100 is semi-circular, the application display information defines the window 130 within the area 120 and the window 140 within the area 160.

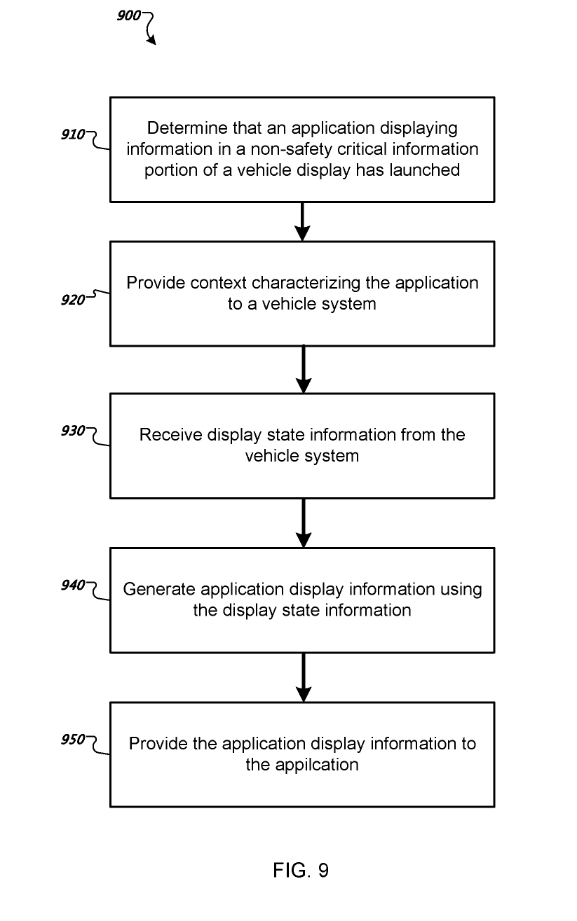

FIG. 9 is a flowchart of an example process 900 for providing graphics data to a vehicle system based on display state information. The process 900 is performed by a system of one or more computers. For example, a user display system, e.g., the user display system 200 of FIG. 2, appropriately programmed in accordance with this specification, can perform the process 900.

A user display system determines that an application has launched (Step 910). Applications provide data for displaying in the non-safety critical information portion of the vehicle display. The data provided by the applications may include texts, pictures, or any visual graphics that can be displayed in the vehicle display.

When the user display system determines that an application has launched, the user display system provides context to the vehicle system (Step 920). Context includes data that characterizes the launched application. For example, when an application has launched, the user display system provides context that characterizes the launched application to the vehicle system. In some implementations, where multiple applications have launched, the context may include data that characterizes the multiple applications that have launched. In some implementations, where one application has launched while another application is already running, the user display system can provide updated context that characterizes the newly launched application to the vehicle system.

The vehicle system receives the context from the user display system. Based on the context, the vehicle system generates display state information. The display state information includes data that determines the safety critical information portion and the non-safety critical information portion within the vehicle display.

In some implementations, the display state information includes data that determines the sizes and arrangements of the safety critical information portion and the non-safety critical information portion.

The user display system receives the display state information from the vehicle system (Step 930). The display state information includes data identifying the area of the vehicle display that is allocated to the non-safety critical information portion.

The user display system generates application display information using the display state information (Step 940). The application display information includes data defining an area that is allocated for displaying non-safety critical information generated by the launched application. To generate the application display information, the user display system determines display capability of the launched application. Then, the user display system generates the application display information to define the area that is allocated for displaying the non-safety critical information in a manner that is appropriate for the display capability of the launched application.

The user display system provides the application display information to the launched application (Step 950). The launched application receives the application display information and generates graphics data to be displayed in the area that is allocated for displaying non-safety critical information.

The launched application provides the graphics data to the user display system. The user display system provides the received graphics data to the vehicle system for display in the non-safety critical information portion of the vehicle display. The vehicle system displays the graphics data in the non-safety critical information portion of the vehicle display.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand—alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially be claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
determining that an application that displays data in a non-safety critical information portion of a vehicle display has launched, wherein the vehicle display displays non-safety critical information in the non-safety critical information portion and safety critical information in a safety critical information portion of the display;
providing, to a vehicle system that manages the vehicle display, context that characterizes the application;
receiving, from the vehicle system, display state information that identifies an area of the vehicle display that is currently allocated to the non-safety critical information portion;
generating, using the display state information, application display information that defines an area allocated for displaying the non-safety critical information generated by the application; and
providing the application display information to the application.

2. The method of claim 1, further comprising:
receiving graphics data from the application; and
providing, to the vehicle system, the graphics data for display in the non-safety critical information portion of the vehicle display.

3. The method of claim 1, wherein the application display information defines the area allocated for displaying the graphics data generated by the application as an area that substantially matches the area of the vehicle display that is currently allocated to the non-safety critical information portion.

4. The method of claim 1, wherein the application display information defines the area allocated for displaying the graphics data generated by the application as one window within the area of the vehicle display that is currently allocated to the non-safety critical information portion.

5. The method of claim 1, wherein the application display information defines the area allocated for displaying the graphics data generated by the application as one window that is overlaid, in part or in full, over the area of the vehicle display that is currently allocated to the non-safety critical information portion.

6. The method of claim 1, wherein the application display information defines the area allocated for displaying the graphics data generated by the application as multiple windows within the area of the vehicle display that is currently allocated to the non-safety critical information portion.

7. The method of claim 1, wherein the application display information defines the area allocated for displaying the graphics data generated by the application as a first window and a second window that is smaller than the first window and is overlaid over the first window.

8. The method of claim 1, wherein generating the application display information comprises:
determining a display capability of the application; and
generating the application display information to define the area in a manner that is appropriate for the display capability of the application.

9. A system comprising:
one or more computers and one or more storage devices storing instructions that when executed by the one or more computers cause the one or more computers to perform operations comprising:
determining that an application that displays data in a non-safety critical information portion of a vehicle display has launched, wherein the vehicle display displays non-safety critical information in the non-safety critical information portion and safety critical information in a safety critical information portion of the display;
providing, to a vehicle system that manages the vehicle display, context that characterizes the application;
receiving, from the vehicle system, display state information that identifies an area of the vehicle display that is currently allocated to the non-safety critical information portion;
generating, using the display state information, application display information that defines an area allocated for displaying the non-safety critical information generated by the application; and
providing the application display information to the application.

10. The system of claim 9, further comprising:
receiving graphics data from the application; and
providing, to the vehicle system, the graphics data for display in the non-safety critical information portion of the vehicle display.

11. The system of claim 9, wherein the application display information defines the area allocated for displaying the graphics data generated by the application as an area that substantially matches the area of the vehicle display that is currently allocated to the non-safety critical information portion.

12. The system of claim 9, wherein the application display information defines the area allocated for displaying the graphics data generated by the application as one window within the area of the vehicle display that is currently allocated to the non-safety critical information portion.

13. The system of claim 9, wherein the application display information defines the area allocated for displaying the graphics data generated by the application as one window that is overlaid, in part or in full, over the area of the vehicle display that is currently allocated to the non-safety critical information portion.

14. The system of claim 9, wherein the application display information defines the area allocated for displaying the graphics data generated by the application as multiple windows within the area of the vehicle display that is currently allocated to the non-safety critical information portion.

15. The system of claim 9, wherein the application display information defines the area allocated for displaying the graphics data generated by the application as a first window and a second window that is smaller than the first window and is overlaid over the first window.

16. The system of claim 9, wherein generating the application display information comprises:
determining a display capability of the application; and
generating the application display information to define the area in a manner that is appropriate for the display capability of the application.

17. One or more computer-readable media storing instructions that when executed by one or more computers cause the one or more computers to perform operations comprising:
determining that an application that displays data in a non-safety critical information portion of a vehicle display has launched, wherein the vehicle display displays non-safety critical information in the non-safety critical information portion and safety critical information in a safety critical information portion of the display;
providing, to a vehicle system that manages the vehicle display, context that characterizes the application;
receiving, from the vehicle system, display state information that identifies an area of the vehicle display that is currently allocated to the non-safety critical information portion;
generating, using the display state information, application display information that defines an area allocated for displaying the non-safety critical information generated by the application; and
providing the application display information to the application.

18. The computer-readable medium of claim 17, further comprising:
receiving graphics data from the application; and
providing, to the vehicle system, the graphics data for display in the non-safety critical information portion of the vehicle display.

19. The computer-readable medium of claim 17, wherein the application display information defines the area allocated for displaying the graphics data generated by the application as an area that substantially matches the area of the vehicle display that is currently allocated to the non-safety critical information portion.

20. The computer-readable medium of claim 17, wherein the application display information defines the area allocated for displaying the graphics data generated by the application as one window within the area of the vehicle display that is currently allocated to the non-safety critical information portion.
